(19) United States
(12) Patent Application Publication
(10) Pub. No.: US 2014/0209399 A1
(43) Pub. Date: Jul. 31, 2014

(54) METHOD AND APPARATUS FOR FACILITATING PASSENGER EXERCISE WHILE OCCUPYING A SEAT OF A VEHICLE

(71) Applicant: Ali Mireshghi, Saratoga, CA (US)

(72) Inventor: Ali Mireshghi, Saratoga, CA (US)

(21) Appl. No.: 13/751,063

(22) Filed: Jan. 26, 2013

(51) Int. Cl. B60L 11/00; A63B 21/00

(52) U.S. Cl. CPC B60L 11/007
USPC 180/65.31; 482/92; 482/121

(57) ABSTRACT

An apparatus for facilitating passenger exercise may comprise one or more pedals provided arranged to be operated by a passenger of a vehicle and allow the passenger to exert pressure on the pedal, while occupying a passenger seat of the vehicle. A compression unit coupled to the at least one pedal to receive the exerted pressure on the at least one pedal. The compression unit may function in at least one of a passive mode or an active mode. The apparatus may further comprise one or more handles operable by a passenger of a vehicle to exercise, and configured to allow the passenger to pool the one more handles, while occupying a seat of the vehicle. A string may be coupled to the one or more handles, and may be applicable to receive a force resulting from pooling the handle. A pulley may be operable to receive the string.

The subject technology relates in general to exercise equipment, and in particular, but not restricted, to methods and apparatuses for facilitating passenger exercise while occupying a seat of a vehicle.

### BACKGROUND

While travel takes people to desired vacation spots and facilitates great site seeing, nature exploration, visiting family and friends, business meetings, and the like, just thinking about sitting almost motion-less in a car or airplane seat for hours may take the joy away from some people. Specially, people with certain diseases or health problems, such as back pain, deep vein thrombosis (DVT), and the like may suffer more from prolong sitting in car or airplane. For example, DVT can occur when a blood cloth forms in a vein deep inside a muscle, more often in leg muscles, but also can occur in arms and other areas of the body. The blood cloth, in DVT, can block blood circulation or lodge in a blood vessel in brain, heart, lung, or other areas and can be lethal. Poor blood circulation is known as the main cause of DVT. Sitting or inactivity for a long time may increase the risk of DVT.

Therefore, there is a need for provisions in vehicles such as cars and airplanes to facilitate passenger exercise while occupying a seat of the vehicle.

### SUMMARY

In an aspect of the subject technology, an apparatus for facilitating passenger exercise may comprise one or more pedals arranged to be operated by a passenger of a vehicle and allow the passenger to exert pressure on the pedal, while occupying a passenger seat of the vehicle. A compression unit may be coupled to the at least one pedal to receive the exerted pressure on the at least one pedal. The compression unit may function in at least one of a passive mode or an active mode.

In another aspect, an apparatus may further comprise one or more handles operable by a passenger of a vehicle to exercise, and configured to allow the passenger to pool the one more handles, while occupying a seat of the vehicle. A string may be coupled to the one or more handles, and may be applicable to receive a force resulting from pooling the handle. A pulley may be operable to receive the string.

In yet another aspect, a method for facilitating passenger exercise may comprise arranging one or more pedals operable by a passenger of a vehicle to allow the passenger to exert pressure on the pedal, while occupying a passenger seat of the vehicle. A compression unit may be coupled to the at least one pedal to receive the exerted pressure on the at least one pedal. The compression unit may function in at least one of a passive mode or an active mode.

In yet another aspect, a method for facilitating passenger exercise may comprise providing one or more handles operable by a passenger of a vehicle to exercise, and configured to allow the passenger to pool the one more handles, while occupying a seat of the vehicle. A string may be coupled to the one or more handles, and may be applicable to receive a force resulting from pooling the handle. A pulley may be configured to be operable to receive the string.

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

### BRIEF DESCRIPTION OF THE DRAWINGS

FIGS. 1A-1C are conceptual diagrams of an example of an apparatus for facilitating for a passenger of a vehicle to exercise using foot pedals.

FIGS. 2A-2C are conceptual diagrams of examples of a compression unit of the apparatus of FIGS. 1A-1B.

FIGS. 3A-3B are conceptual diagrams of an example system for converting mechanical energy of the apparatus of FIGS. 1A and 1B to electrical energy.

FIGS. 4A-4C are conceptual diagrams of examples of apparatuses for facilitating for a passenger of a vehicle to perform exercise by hands.

FIG. 5 is a conceptual block diagram of an example of a method for facilitating for a passenger of a vehicle to exercise using foot pedals.

FIG. 6 is a conceptual block diagram of an example of a method for facilitating for a passenger of a vehicle to perform exercise by hands.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

Broadly and generally, in one aspect, the subject technology facilitates for a passenger of a vehicle (e.g., a terrestrial vehicle, such as a car, bus, truck etc. and a space vehicle, such as an airplane) to perform exercise while sitting in a passenger seat of the vehicle. The exercise may be performed by feet or hands and may be significantly beneficial to many passengers, specially the passengers with certain impairments such as back pain, restless syndrome, deep vein thrombosis (DVT), and can improve blood circulation.

In one or more aspects, the subject technology can be implemented in both new vehicles and existing vehicles with low cost. The subject technology has no hazardous aspects and can be implemented in a way that performing the exercise may not cause any nuisance or inconvenience for other passengers. In one or more aspects of the subject technology, electrical energy may be generated and stored in one or more batteries (e.g., batteries of the vehicle) by conversion of the mechanical energy resulting from the exercise by the passenger using the subject exercise apparatus. The energy production may be a by-product and not the main objective of the present disclosure. The basic objective is to allow passenger of the vehicle to have some physical activity, which not only amuses the passenger in long trips, but also enhances blood circulation and may relief muscles of the back, legs, and shoulders from stress resulting from prolong sitting.

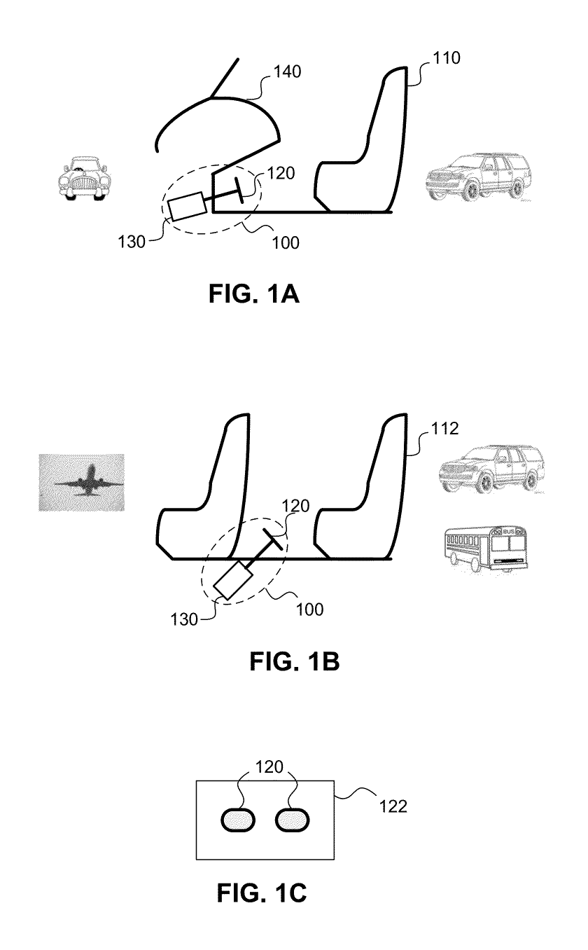

FIGS. 1A-1C are conceptual diagrams of an example of an apparatus 100 for facilitating for a passenger of a vehicle to exercise using foot pedals 120. The passenger may be passenger of a vehicle for example a car or truck, of which, for simplicity, the passenger seat 110, and the dashboard 140 are shown. The one or more pedals 120 (e.g., two, only one of which is shown for simplicity) may be used by the passenger, occupying the passenger seat 110, to perform exercise by pressing on the one or two pedals by foot. The two pedals 120 may be pressed in a reciprocal motion, such that when one foot is pressing down on a pedal, the other foot is being pushed up by the other pedal. The exercise apparatus may include one or more compression units 130 coupled to the one or more pedals 120. The compression units 130 may be configured to function in at least one of a passive mode or an active mode as discussed herein.

In one or more aspects, as shown in FIG. 1B, the exercise apparatus 110 may be provided for a passenger occupying a seat 112 (e.g., a rear seat of a car or truck, or a seat of a bus, an airplane, and the like). The pedals 120 may be activated (e.g., released from a rest position) by a switch operable by the passenger or an operator of the vehicle (e.g., a driver, a flight attendant, and the like). The switch may be located on a side handle or any other place accessible by the passenger. In one or more aspects, the switch may be operable by a remote control or a touch-sensitive display.

In one or more aspects of the subject technology, the pedals 120 may be placed in a suitable position for the passenger to comfortably exercise using the pedals, without causing any nuisance to the other passengers of the vehicle. The pedals 120, when in the rest position, as shown in FIG. 1C, may be flush with a surrounding surface 122, and only be released for operation by the switch. In one or more aspects, the apparatus 100 may be implemented as an assembly that can be moved to a suitable space underneath a passenger seat. In an aspect, the pedals 120 may be configured to have surfaces that can stimulate (e.g. massage or tickle) the bottom of foot for further relief and foot blood circulation.

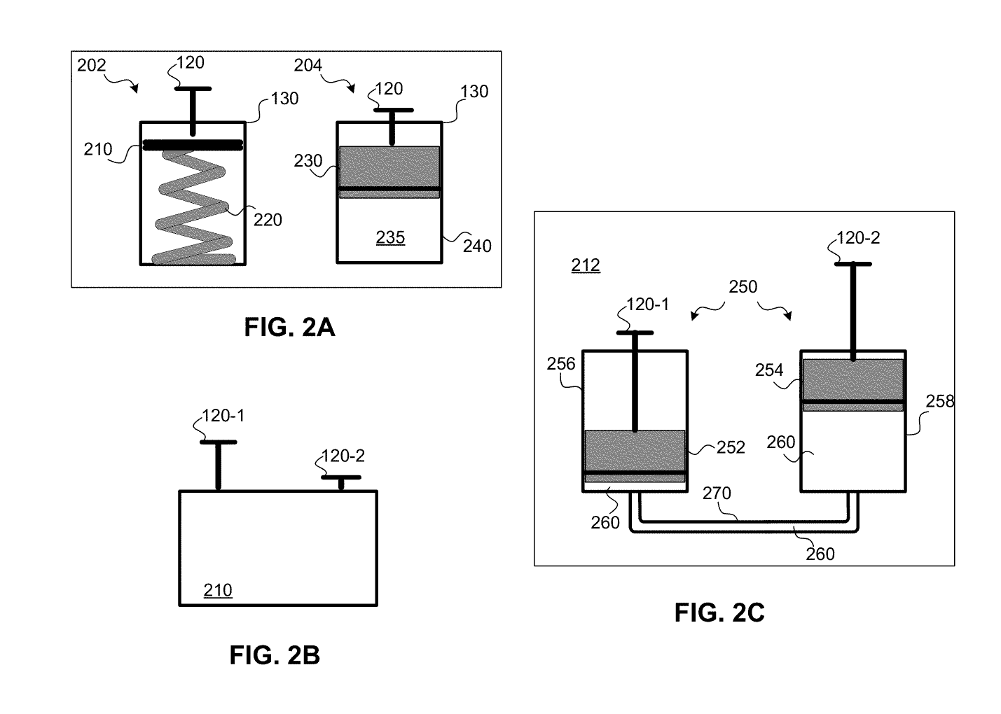

FIGS. 2A-2C are conceptual diagrams of examples of a compression unit 130 of the apparatus of FIGS. 1A-1B. In FIG. 2A, embodiments 202 and 204 of the apparatus 100 are shown. In the embodiments 202 and 204, the compression units 130 are configured to be operated in the passive mode. In the embodiment 202, the pressure exerted on the pedal 120 may be received, for example, by a plate 210 coupled to a spring 220. In the embodiment 204, the pressure exerted on the pedal 120 may be received, for example, by a piston 230, which can transfer the pressure to a compressible medium 235. In one or more aspects, other mechanisms may be used for absorbing the pressure exerted to the pedal 120 and to provide a resistance to the pedal 120.

In an aspect of the disclosure, the compression unit 210 of FIG. 2B may be operable in the active mode to transfer a pressure exerted by one foot to pedal 120-1 to another pedal 120-2 which can push the other foot of the passenger up. It is understood that various mechanisms may be applied by a person skilled in the art for implementing the compression unit 210. For example, the embodiment 212 may include two compression units 250, in which cylinders 256 and 258 contain a non-compressible medium 260 (e.g., a fluid, such as brake fluid, or the like) that can be transferred through the coupling tube 270 (e.g., made of a metal, rubber, polyvinyl chloride, or the like) from one cylinder to the other cylinder.

For example, when pedal 120-1 is pressed, the pressure exerted on pedal 120-1 may be transferred through a piston 252, coupled to the pedal 120-1, to the medium 260, which in turn can transfer the pressure to the piston 254, coupled to pedal 120-2, and push the pedal 120-2 upward. The compression units 250 may, therefore, facilitate reciprocal motion of the pedals 120-1 and 120-2, which allow the passenger to periodically exert pressure on the pedals 120-1 and 120-2 by two feet, so that when one foot is pressing on one pedal (e.g., 120-1) the other foot is being pressed (e.g., pushed up) by the other pedal (e.g., 120-2).

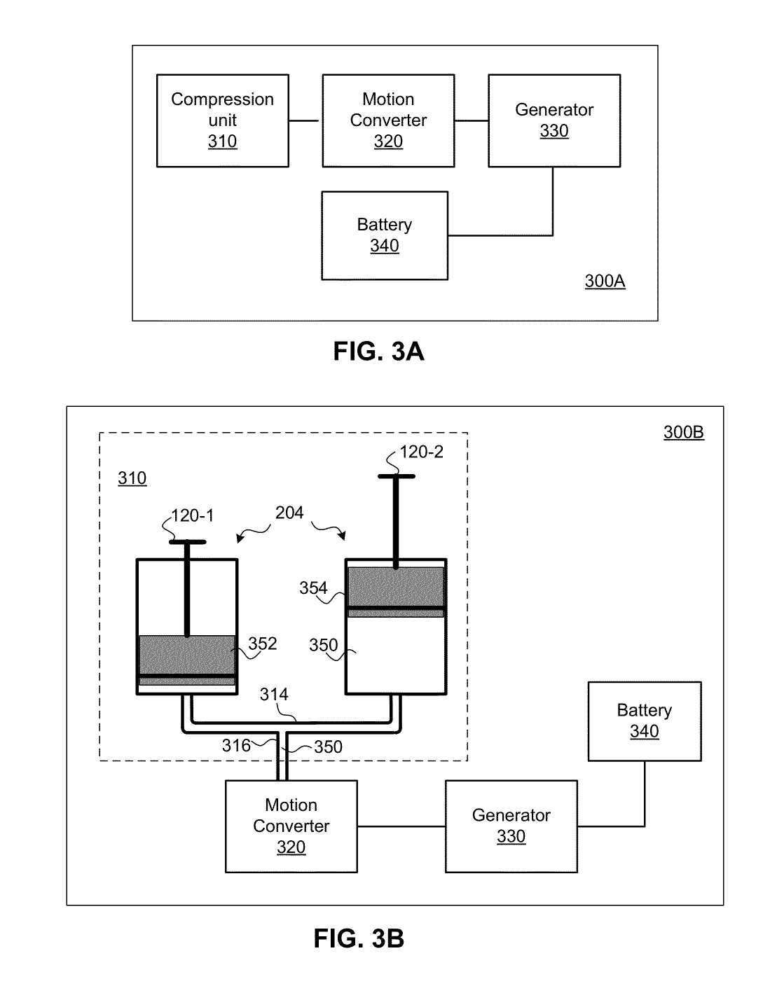

FIGS. 3A-3B are conceptual diagrams of example systems 300A and 300B for converting mechanical energy of the apparatus 100 of FIGS. 1A and 1B to electrical energy. The system 300A may include a compression unit 310, a motion converter 320, a generator 330, and one or more batteries 340. The compression unit 310 may be similar to any of the compression units 250 of FIG. 2C. For example, as shown in FIG. 3B, in the compression unit 310, the tube 314 has an opening to a coupling tube 316 that allows the non-compressible medium 350 (e.g., a fluid, such as brake fluid, or the like) to flow to the motion converter 320. The medium 350 may not only transfer pressure from one pedal (e.g., 120-1) to the other pedal (e.g., 120-2) to raise the other pedal, but can also exert, at least a portion of the pressure exerted by the pressing foot, through the coupling tube 316 to the motion converter 320.

The motion converter 320 may be operable to receive a linear motion of an element of the compression unit (e.g., one of pistons 352 or 354) and to convert the linear motion to a rotational motion. It is understood that the motion converter 320 may include, cylinders, pistons, gears, bearings, wheels, pulleys, belts, or other mechanical components that can work together to convert the pressure received from the medium 350 to a rotational movement. The rotational movement can be coupled to the electric generator 330. The generator 330 may convert the received rotational motion to a low-voltage direct-current (DC) electrical power that can be stored in the one or more batteries 340. In one or more aspects, the one or more batteries 340 may include the regular rechargeable batteries of the vehicle or special batteries for providing power for other tools that can help the passenger get more relief. For example, the stored electrical power may be used to power one or more calf -muscle pumps that can be provided to the passenger to increase blood circulation in the legs even further.

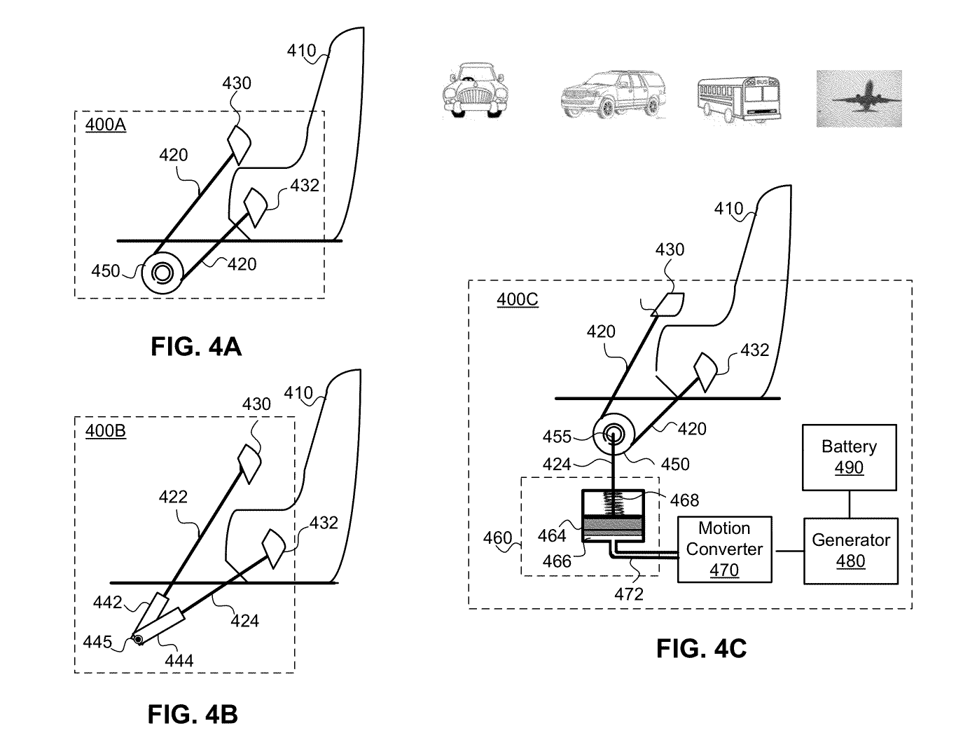

FIGS. 4A-4C are conceptual diagrams of examples of apparatuses 400A-400C for facilitating for a passenger of a vehicle to perform exercise by hands. The hand-exercise apparatuses 400A-400C may be provided for a passenger of vehicle occupying a seat 410 of a vehicle (e.g., a terrestrial vehicle, such as a car, bus, truck etc. and a space vehicle, such as an airplane) to perform exercise with hands. The hand-exercise apparatus 400A may include handles 430 and 432, a string 420 and a pulley 450. The handles 430 and 432 may be configured to be operable by the passenger to exercise and may allow the passenger to pool the handles, while occupying the seat 410. The string 420 may be coupled, at the first and the second end of the string 420, to the handles 430 and 432. The pulley 450 may be fixed to a structure of the vehicle and may be operable to receive the string and change a direction or a point of application of the force resulting from pooling the handles 430 and 432. The pulley 450 is shown as being in the plane of the shown cross-sectional view, for illustration purpose. In practice, the plane of the pulley 450 may be in a rotated angle (e.g., 90°) with respect to the shown plane of the pulley (e.g., plane of the cross-sectional view). The passenger may pull the handles 430 and 432 periodically in a reciprocal motion to perform hand and shoulder exercise.

In one or more implementations of the subject technology, the hand-exercise apparatus 400B may include handles 430 and 432, string 422 and 424, and traction elements 442 and 444. The strings 422 is coupled (e.g., fixed) to handles 430, in one end, and to the traction element 442, in the other end. The strings 424 is coupled (e.g., fixed) to handles 432, in one end, and to the traction element 444, in the other end. The fraction elements 442 and 444 may be fixed by a fixture 445 to a structure of the vehicle. The traction elements 442 and 444 may include, for example, traction springs, or other tractable elements, which can be stretched when pulling forces are exerted by the strings 422 and 424 to the traction elements 442 and 444. The exerted pulling force by the strings 422 and 424 may result from pulling the handles 430 and 432 by the passenger occupying the seat 410.

Other mechanisms than the ones applied in the apparatuses 400A and 400B may be used by a person skilled in the art to provide the described functionalities with respect to the apparatuses 400A and 400B. In one or more aspects of the present technology, the apparatuses 400A and 400B may be implemented as assemblies that can be placed, when not in use by the passenger, under a seat of the vehicle.

In one or more implementation, the hand-exercise apparatus 400C may include the handles 430 and 432, the string 420, the pulley 450 a rod 424, a compression unit 460, a motion converter 470, a generator 480, and one or more batteries 490. In one aspect, the handles 430 and 432 may be operable to be used, as in the hand-exercise apparatus 400A, by two hands in a periodic reciprocal motion, where one hand works against the other hand. In this scenario the center 455 of the pulley 450 may be locked to a fixed position. The pulley 450 is shown as being in the plane of the shown cross-sectional view, for illustration purpose. In practice, the plane of the pulley may be in a rotated angle (e.g., 90°) with respect to the shown plane of the pulley (e.g., plane of the cross-sectional view).

In another aspect, the center 455 of the pulley 450 may be unlocked and free to move up and down, as the passenger holding the handles 430 and 432 pulls the handles up, simultaneously by both hands, the rod 424 pulls up piston 464 and compresses a spring 468 of the compression unit 460. The pulling up of the piston 464 may suck a non-compressible medium 466 (e.g., a fluid, such as brake fluid) out from the motion converter 470, and when both handles 430 and 432 are allowed to return back, by the passenger, the sprig 424 may decompress and as a result push down the piston 464, which in turn pushes the medium 466 into the motion converter 470, through the coupling tube 472.

The pushing of the medium 466 into the motion converter 470 may cause motion converter to transfer the linear motion of an element (e.g., anther piston or a plate, not shown for simplicity), pushed into the motion converter 470 by the pressure of the medium 466, to a rotational motion. The pushing and pulling of the element may continue, as the passenger exercise with both hands together, and may sustain the rotational motion. The rotational motion may be converted to electrical power, by the generator 480, which can be stored in one or more batteries 490. In one or more aspects of the present technology, the apparatus 400C may be implemented as an assembly that can be placed, when not in use by the passenger, under a seat of the vehicle.

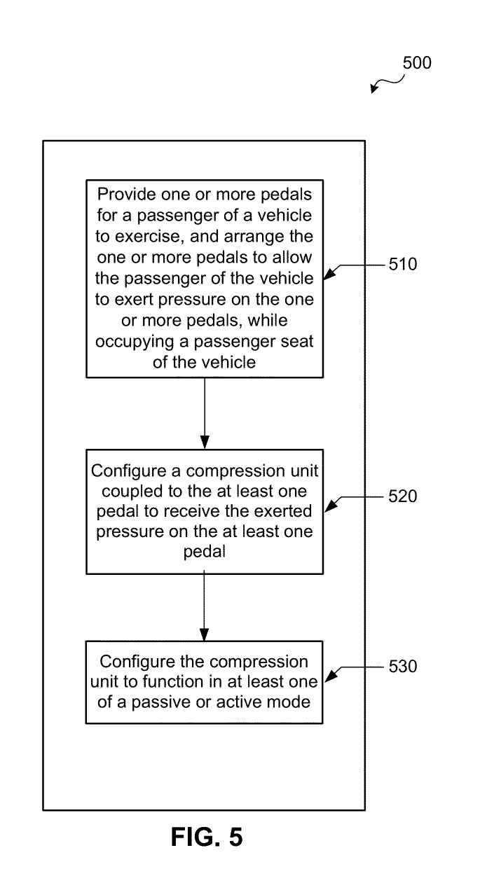

FIG. 5 is a conceptual block diagram of an example of a method 500 for facilitating for a passenger of a vehicle to exercise using foot pedals 120 of FIGS. 1A-1C. At operation block 510, one or more pedals (e.g., 120 of FIGS. 1A-1C) may be configured to be operated by a passenger of a vehicle to exercise. The one or more pedals may be arranged to allow the passenger of the vehicle to exert pressure on the one or more pedals, while occupying a passenger seat (e.g., 110 or 112 of FIGS. 1A-1B) of the vehicle.

At operation block 520, a compression unit (e.g., 130 of FIGS. 1A-1B or FIG. 2A, or 210 and 212 of FIGS. 2B and 2C) may be coupled to the at least one pedal and be configured to receive the exerted pressure on the at least one pedal. At operation block 530 the compression unit may be configured to function in at least one of a passive or active mode, as discussed above.

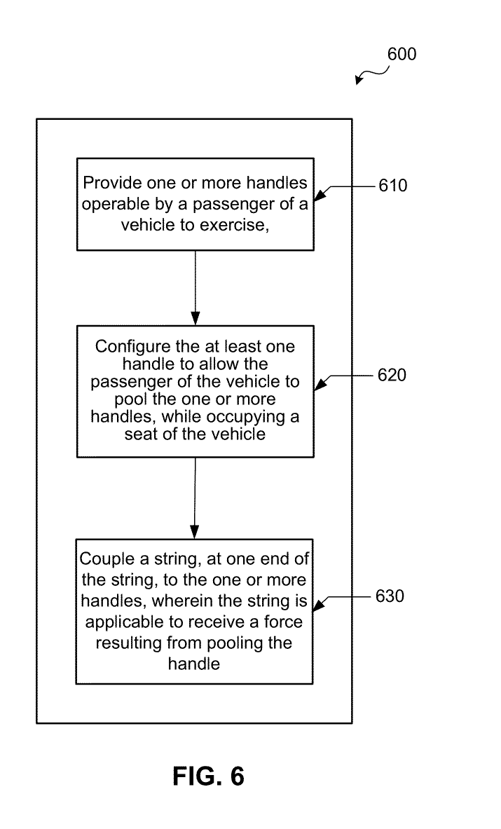

FIG. 6 is a conceptual block diagram of an example of a method 600 for facilitating for a passenger of a vehicle to perform exercise by hands. At operation block 610, one or more handles (e.g., 430 and 432 of FIGS. 4A-4C) may be provided. The handles may be operable by the passenger of the vehicle to exercise. The one or more handles may be configured to allow the passenger of the vehicle to pool the one or more handles, while occupying a seat (e.g., 410 of FIGS. 4A-4C) of the vehicle (operation block 620). At operation block 630, a string (e.g., 420, 422, and 424 of FIGS. 4A-4C) may be coupled, at a first end of the string, to the one or more handles. The string may be applicable to receive a force resulting from pooling the handle b the passenger.

### The Numbered Clauses:

The subject technology is illustrated, for example, according to various aspects described below. Numbered clauses are provided below for convenience. These are provided as examples, and do not limit the subject technology.
1. An apparatus (e.g., 100 of FIGS. 1A and 1B) for facilitating passenger exercise comprising:

at least one pedal (e.g., 120 of FIGS. 1A-1C) configured to be operated by a passenger of a vehicle to exercise, the at least one pedal being arranged to allow the passenger of the vehicle to exert pressure on the at least one pedal, while occupying a passenger seat of the vehicle; and

a compression unit (e.g., 130 of FIGS. 1A and 1B) coupled to the at least one pedal and configured to receive the exerted pressure on the at least one pedal,

wherein the compression unit is configured to function in at least one of a passive mode (e.g., 202 and 204 of FIG. 2A) or an active mode (e.g., 212 of FIG. 2C).
2. The apparatus of clause 1, wherein,
the vehicle is at least one of a terrestrial vehicle or a space vehicle,
the terrestrial vehicle includes at least one of a car, a bus, a truck, or a train,
the space vehicle includes an airplane.
3. The apparatus of clause 1, wherein,

the at least one pedal is arranged to receive the pressure from a foot of the passenger,

exerting pressure includes periodically exerting pressure,

the at least one pedal is configured to be activated by a switch,

when not activated, the at least one pedal sits in a position flush with a surface area surrounding the at least one pedal,

the switch is operable by at least one of the passenger of the vehicle or an operator of the vehicle,

the switch is operable by at least one of a remote control, or a touch-sensitive display.
4. The apparatus of clause 1, wherein the compression unit is configured to function in the passive mode and in the passive mode, the compression unit comprises at least one compression element that receives the exerted pressure on the at least one pedal, and wherein the compression element includes a spring.
5. The apparatus of clause 1, wherein the compression unit is configured to function in the active mode, and in the active mode, the compression unit comprises a medium capable of transferring the exerted pressure on the at least one pedal, at least partially, to at least one of an object or a motion convertor.
6. The apparatus of clause 5, wherein the medium is applicable to transfer the exerted pressure on the at least one pedal, at least partially, to the object including another pedal to raise the other pedal, and wherein the at least one pedal and the other pedal are configured to receive pressure exerted by feet of the passenger in a reciprocal motion.
7. The apparatus of clause 5, further comprising the motion converter operable to receive a linear motion of an element of the compression unit and to convert the linear motion to a rotational motion, and wherein the element includes the medium.
8. The apparatus of clause 7, further comprising:
a generator operable to receive the rotational motion and to generate electrical power; and
at least one battery operable to store the generated electrical power.
9. An apparatus for facilitating passenger exercise comprising:

at least one handle configured to be operable by a passenger of a vehicle to exercise, the at least one handle configured to allow the passenger of the vehicle to pool the at least one handle, while occupying a seat of the vehicle; and

a string coupled, at one end of the string, to the at least one handle,

wherein the string is applicable to receive a force resulting from pooling the handle.
10. The apparatus of clause 9, wherein the vehicle comprises at least one of a terrestrial vehicle or a space vehicle, wherein the terrestrial vehicle includes at least of a car, a bus, a truck, or a train, wherein the space vehicle includes an airplane, and wherein the method further comprises a pulley fixed to an structure of the vehicle and operable to receive the string and change at least one of a direction or a point of application of the force resulting from pooling the handle.
11. The apparatus of clause 10, wherein the string is coupled, at least one of directly or through one or more motion conversion mechanisms, to an electrical power generator, wherein the one or more motion conversion mechanisms include at least one of gears, bearings, or wheels, and wherein the electrical power generator is operable to generate electrical power, and wherein the apparatus further includes one or more battery operable to store the generated electrical power.
12. The apparatus of clause 9, wherein another end of the string is coupled to a traction element fixed to a structure of to the vehicle that is operable to receive the force resulting from pooling of the handle, wherein the traction element is a spring.
13. The apparatus of clause 9, wherein another end of the string is coupled to another handle, which is also configured to allow the passenger of the vehicle to exercise, wherein the at least one handle and the other handle are arranged to be pooled by two hands of the passenger in a reciprocal motion, and wherein the apparatus further includes a pulley coupled to a motion conversion mechanism that can convert a translational motion of the pulley to a rotational motion to be used by a generator to generate electrical power.
14. A method for facilitating passenger exercise comprising:

configuring at least one pedal to be operated by a passenger of a vehicle to exercise, and arranging the at least one pedal to allow the passenger of the vehicle to exert pressure on the at least one pedal, while occupying a passenger seat of the vehicle;

providing a compression unit coupled to the at least one pedal, and configuring the compression unit to receive the exerted pressure on the at least one pedal; and

configuring the compression unit to function in at least one of a passive or active mode.
15. The method of clause 14, wherein exerting pressure includes periodically exerting pressure, and the method further comprises:

arranging the at least one pedal to receive the pressure from a foot of the passenger,

configuring the at least one pedal to be activated by a switch,

configuring the at least one pedal to sit, when not activated, in a position flush with a surface area surrounding the at least one pedal, wherein,

the switch is operable by at least one of the passenger of the vehicle or a an operator of the vehicle,

the switch is operable by at least one of a remote control, or a touch-sensitive display.
16. The method of clause 14, further comprising:

configuring the compression unit to function in the passive mode, wherein in the passive mode, the compression unit comprises at least one compression element that receives the exerted pressure on the at least one pedal, and wherein the compression element includes a spring.
17. The method of clause 14, further comprising:

configuring the compression unit to function in the active mode, wherein in the active mode, the compression unit comprises a medium capable of transferring the exerted pressure on the at least one pedal, at least partially, to at least one of an object or a motion convertor.
18. The method of clause 14, further comprising:
providing a motion converter operable to receive a linear motion of an element of the compression unit and to convert the linear motion to a rotational motion; and providing a generator operable to receive the a rotational motion and generate electrical power, and wherein
the generator is further operable to store the generated electrical power in at least one storage medium including a battery.
19. A method for facilitating passenger exercise comprising:

providing at least one handle operable by a passenger of a vehicle to exercise, and configuring the at least one handle to allow the passenger of the vehicle to pool the at least one handle, while occupying a seat of the vehicle; and

coupling a string, at a first end of the string, to the at least one handle,

wherein the string is applicable to receive a force resulting from pooling the handle.
20. The method of clause 19, further comprising providing:

a pulley operable to receive the string and change at least one of a direction or a point of application of the force resulting from pooling the handle,

one or more motion conversion mechanisms including at least one of gears, bearings, or wheels,

an electrical power generator operable to generate electrical power, and

one or more batteries operable to store the generated electrical power, wherein at least one of a second end of the string or the pulley is coupled, at least one of directly or through the one or more motion conversion mechanisms, to the electrical power generator.
21. The method of clause 19, further comprising:

coupling the second end of the string to at least one of:

a traction element fixed to an structure of to the vehicle that is operable to receive the force resulting from pooling of the handle, wherein the traction element is a spring, or

another handle, which is also provided for the passenger of the vehicle to exercise, and a pulley fixed to an structure of the vehicle and operable to receive the string and change at least one of a direction or a point of application of the force resulting from pooling each of the handle or the other handle, and wherein the at least one handle and the other handle are provided to be used by two hands of the passenger in a reciprocal motion.
22. An apparatus for facilitating passenger exercise comprising means for performing the methods of any of the preceding method clauses.

The subject technology has been described with particular illustrative configurations. It is to be understood that the subject technology is not limited to the above-described configurations and that various changes and modifications may be made by those of ordinary skill in the art without departing from the scope if the subject technology. For example, various configurations have been described with reference to basic and fundamental implementation of the subject technology. Practitioners of the art will recognize that several variations are possible by using different configurations, for example, using more complex mechanisms and structure to implement the concepts of the present disclosure, as described above with respect to various figures.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” For example, a pedal may refer to one or more pedals, a spring may refer to one or more spring, a pulley may refer to one or more pulleys, and a battery may refer to one or more battery.

In one aspect, the term “coupled” or the like may refer to being directly coupled. In another aspect, the term “coupled” or the like may refer to being indirectly coupled.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An apparatus for facilitating passenger exercise comprising:
at least one pedal configured to be operated by a passenger of a vehicle to exercise, the at least one pedal being arranged to allow the passenger of the vehicle to exert pressure on the at least one pedal, while occupying a passenger seat of the vehicle; and
a compression unit coupled to the at least one pedal and configured to receive the exerted pressure on the at least one pedal,
wherein the compression unit is configured to function in at least one of a passive mode or an active mode.

2. The apparatus of claim 1, wherein,
the vehicle is at least one of a terrestrial vehicle or a space vehicle,
the terrestrial vehicle includes at least one of a car, a bus, a truck, or a train,
the space vehicle includes an airplane.

3. The apparatus of claim, wherein,
the at least one pedal is arranged to receive the pressure from a foot of the passenger,
exerting pressure includes periodically exerting pressure,
the at least one pedal is configured to be activated by a switch,
when not activated, the at least one pedal sits in a position flush with a surface area surrounding the at least one pedal,
the switch is operable by at least one of the passenger of the vehicle or an operator of the vehicle,
the switch is operable by at least one of a remote control, or a touch-sensitive display.

4. The apparatus of claim 1, wherein the compression unit is configured to function in the passive mode and in the passive mode, the compression unit comprises at least one compression element that receives the exerted pressure on the at least one pedal, and wherein the compression element includes a spring.

5. The apparatus of claim 1, wherein the compression unit is configured to function in the active mode, and in the active mode, the compression unit comprises a medium capable of transferring the exerted pressure on the at least one pedal, at least partially, to at least one of an object or a motion convertor.

6. The apparatus of claim 5, wherein the medium is applicable to transfer the exerted pressure on the at least one pedal, at least partially, to the object including another pedal to raise the other pedal, and wherein the at least one pedal and the other pedal are configured to receive pressure exerted by feet of the passenger in a reciprocal motion.

7. The apparatus of claim 5, further comprising the motion converter operable to receive a linear motion of an element of the compression unit and to convert the linear motion to a rotational motion, and wherein the element includes the medium.

8. The apparatus of claim 7, further comprising:
a generator operable to receive the rotational motion and to generate electrical power; and
at least one battery operable to store the generated electrical power.

9. An apparatus for facilitating passenger exercise comprising:
at least one handle configured to be operable by a passenger of a vehicle to exercise, the at least one handle configured to allow the passenger of the vehicle to pool the at least one handle, while occupying a seat of the vehicle; and
a string coupled, at one end of the string, to the at least one handle,
wherein the string is applicable to receive a force resulting from pooling the handle.

10. The apparatus of claim 9, wherein the vehicle comprises at least one of a terrestrial vehicle or a space vehicle, wherein the terrestrial vehicle includes at least of a car, a bus, a truck, or a train, wherein the space vehicle includes an airplane, and wherein the method further comprises a pulley fixed to an structure of the vehicle and operable to receive the string and change at least one of a direction or a point of application of the force resulting from pooling the handle.

11. The apparatus of claim 10, wherein the string is coupled, at least one of directly or through one or more motion conversion mechanisms, to an electrical power generator, wherein the one or more motion conversion mechanisms include at least one of gears, bearings, or wheels, and wherein the electrical power generator is operable to generate electrical power, and wherein the apparatus further includes one or more battery operable to store the generated electrical power.

12. The apparatus of claim 9, wherein another end of the string is coupled to a traction element fixed to a structure of the vehicle that is operable to receive the force resulting from pooling of the handle, wherein the traction element is a spring.

13. The apparatus of claim 9, wherein another end of the string is coupled to another handle, which is also configured to allow the passenger of the vehicle to exercise, wherein the at least one handle and the other handle are arranged to be pooled by two hands of the passenger in a reciprocal motion, and wherein the apparatus further includes a pulley coupled to a motion conversion mechanism that can convert a translational motion of the pulley to a rotational motion to be used by a generator to generate electrical power.

14. A method for facilitating passenger exercise comprising:
configuring at least one pedal to be operated by a passenger of a vehicle to exercise, and arranging the at least one pedal to allow the passenger of the vehicle to exert pressure on the at least one pedal, while occupying a passenger seat of the vehicle;
providing a compression unit coupled to the at least one pedal, and configuring the compression unit to receive the exerted pressure on the at least one pedal; and
configuring the compression unit to function in at least one of a passive or active mode.

15. The method of claim 14, wherein exerting pressure includes periodically exerting pressure, and the method further comprises:
arranging the at least one pedal to receive the pressure from a foot of the passenger,
configuring the at least one pedal to be activated by a switch,
configuring the at least one pedal to sit, when not activated, in a position flush with a surface area surrounding the at least one pedal, wherein,
the switch is operable by at least one of the passenger of the vehicle or a an operator of the vehicle,
the switch is operable by at least one of a remote control, or a touch-sensitive display.

16. The method of claim 14, further comprising:
configuring the compression unit to function in the passive mode, wherein in the passive mode, the compression unit comprises at least one compression element that receives the exerted pressure on the at least one pedal, and wherein the compression element includes a spring.

17. The method of claim 14, further comprising:
configuring the compression unit to function in the active mode, wherein in the active mode, the compression unit comprises a medium capable of transferring the exerted pressure on the at least one pedal, at least partially, to at least one of an object or a motion convertor.

18. The method of claim 14, further comprising:
providing a motion converter operable to receive a linear motion of an element of the compression unit and to convert the linear motion to a rotational motion; and providing a generator operable to receive the a rotational motion and generate electrical power, and wherein
the generator is further operable to store the generated electrical power in at least one storage medium including a battery.

19. A method for facilitating passenger exercise comprising:
providing at least one handle operable by a passenger of a vehicle to exercise, and configuring the at least one handle to allow the passenger of the vehicle to pool the at least one handle, while occupying a seat of the vehicle; and
coupling a string, at a first end of the string, to the at least one handle,
wherein the string is applicable to receive a force resulting from pooling the handle.

20. The method of claim 19, further comprising providing:
a pulley fixed to a structure of the vehicle and operable to receive the string and change at least one of a direction or a point of application of the force resulting from pooling the handle,
one or more motion conversion mechanisms including at least one of gears, bearings, or wheels,
an electrical power generator operable to generate electrical power, and
one or more batteries operable to store the generated electrical power, wherein at least one of a second end of the string or the pulley is coupled, at least one of directly or through the one or more motion conversion mechanisms, to the electrical power generator.

21. The method of claim 19, further comprising:
coupling the second end of the string to at least one of:
a traction element fixed to an structure of the vehicle that is operable to receive the force resulting from pooling of the handle, wherein the traction element is a spring, or
another handle, which is also provided for the passenger of the vehicle to exercise, and a pulley fixed to an structure of the vehicle and operable to receive the string and change at least one of a direction or a point of application of the force resulting from pooling each of the handle or the other handle, and wherein the at least one handle and the other handle are provided to be used by two hands of the passenger in a reciprocal motion.
